(19) United States
(12) Patent Application Publication
(10) Pub. No.: US 2026/0085939 A1
(43) Pub. Date: Mar. 26, 2026

(54) DRIVER ASSISTANCE METHODS AND DEVICES FOR A HOST VEHICLE

(71) Applicant: Robert Bosch GmbH, Stuttgart (DE)

(72) Inventor: Yuntao Li, Suzhou (CN)

(21) Appl. No.: 19/334,815

(22) Filed: Sep. 20, 2025

(30) Foreign Application Priority Data
Sep. 23, 2024 (CN) 2024 1132 5023.X

(51) Int. Cl. G01C 21/34; G01C 21/16; H04W 4/02; H04W 4/021

(52) U.S. Cl. CPC G01C 21/3461; G01C 21/16; G01C 21/3492; H04W 4/021; H04W 4/025

(57) ABSTRACT

A method for driver assistance for a host vehicle includes storing a trip, the route having n traffic lights and being divided into n+1 sections by the traffic lights. Each intersection at which a traffic light is located has a reference object. The stored trip includes only obtaining and storing the position information of the intersection reference object, the travel length information of each section, and the driving path information of the host vehicle at the intersection. The i-th intersection reference object serves as both the end point of the i-th section and the starting point of the i+1-th section of the trip and is used to correct accumulated positioning errors. The driving path information at the intersection includes driving path guidance information with going straight or turning information and the driving path guidance information is used to connect the road network information of the two intersections. A device, a domain controller, a computer-readable medium, and a computer program product for driver assistance for a host vehicle are also disclosed.

This application claims priority under 35 U.S. C. § 119 to application no. CN 2024 1132 5023.X, filed on Sep. 23, 2024 in China, the disclosure of which is incorporated herein by reference in its entirety.

The present application relates to the field of autonomous/assisted driving of vehicles, and in particular to driver assistance methods and devices for vehicles. The present application further relates to a domain controller for implementing driver assistance and a computer program product comprising a computer program for implementing a driver assistance method.

### BACKGROUND

With the advancement of science and technology, the driver assistance/autonomous driving functions of vehicles are becoming increasingly powerful. When a driver frequently and repeatedly drives a vehicle from one location to another, such as from home to work, to a supermarket, to a station, or vice versa, it is easy for a vehicle with an ADAS to memorize the trip.

Current ADAS generate and store the entire travel path, even the map. This consumes a lot of computing resources and memory and may cause freezes and lags.

In view of the above issues, a more efficient method of memorizing the entire travel path is needed.

### SUMMARY

In view of the above issues, the present disclosure is intended to provide a method and apparatus for driver assistance.

According to one aspect of the present disclosure, a driver assistance method is provided, at least comprising: storing a trip, wherein the trip has n traffic lights along a route from a starting point Ps to an end point Pe and the trip is divided into n+1 sections by the n traffic lights, where n is an integer greater than or equal to 1, wherein the intersection where the i-th traffic light is located has at least one i-th intersection reference object, and i is any integer from 1 to n; wherein storing the trip comprises only acquiring and storing position information of the 1st to n-th intersection reference objects at the 1st to n-th intersections, travel length information of each of the n+1 sections, and driving path information of the host vehicle at the 1st to n-th intersections, wherein the i-th intersection reference object serves as both the end point of the i-th section and the starting point of the i+1-th section of the trip and is used to correct accumulated positioning errors and the driving path information at the intersection includes driving path guidance information with going straight or turning information and the driving path guidance information is used to connect the road network information of the two intersections.

According to another aspect of the present disclosure, a device for driver assistance is provided, at least comprising: a storage module configured to store a trip, wherein the trip has n traffic lights along a route from a starting point Ps to an end point Pe and the trip is divided into n+1 sections by the n traffic lights, where n is an integer greater than or equal to 1, wherein the intersection where the i-th traffic light is located has at least one i-th intersection reference object, and i is any integer from 1 to n; wherein storing the trip comprises only acquiring and storing position information of the 1st to n-th intersection reference objects at the 1st to n-th intersections, travel length information of each of the n+1 sections, and driving path information of the host vehicle at the 1st to n-th intersections, wherein the i-th intersection reference object serves as both the end point of the i-th section and the starting point of the i+1-th section of the trip and is used to correct accumulated positioning errors and the driving path information at the intersection includes driving path guidance information with going straight or turning information and the driving path guidance information is used to connect the road network information of the two intersections.

According to yet another aspect of the present disclosure, a domain controller is provided, comprising at least one processor and a memory coupled with the at least one processor, the memory storing a computer program implementing the method according to the first aspect of the present disclosure when executed by the at least one processor.

The present disclosure further provides a computer program product comprising a computer program which, when executed by a computer, causes the computer to perform the method according to the first aspect of the present disclosure.

### BRIEF DESCRIPTION OF THE DRAWINGS

In the following, examples of the present disclosure will be described in more detail with reference to the accompanying drawings, wherein:

FIG. 1 schematically shows a point-to-point route diagram of a host vehicle from a starting point to an end point according to one example of the present disclosure.

FIG. 2 schematically shows a route diagram of a host vehicle turning right at an intersection according to one example of the present disclosure.

FIG. 3 schematically shows a route diagram of a host vehicle turning left at an intersection according to one example of the present disclosure.

FIG. 4 schematically shows a route diagram of a host vehicle going straight at an intersection according to one example of the present disclosure.

FIG. 5 schematically shows a flow chart of a method for performing a trip on a new route according to one example of the present disclosure.

FIG. 6 schematically shows a flow chart of a method for performing a trip on a previously traveled route according to one example of the present disclosure.

Other objectives and features of the examples herein will become apparent from the detailed description provided below in conjunction with the accompanying drawings. However, it should be understood that the drawings are designed merely for illustrative purposes and are not intended to limit the scope of the present disclosure.

### DETAILED DESCRIPTION

The vehicle of the present disclosure has an advanced driver assistance system (ADAS). The vehicle has at least a camera, a radar and/or LiDAR, and a vehicle speed sensor that may be disposed at any suitable location in the vehicle. Although not mentioned herein, other sensors besides the above mentioned sensors are also possible if necessary.

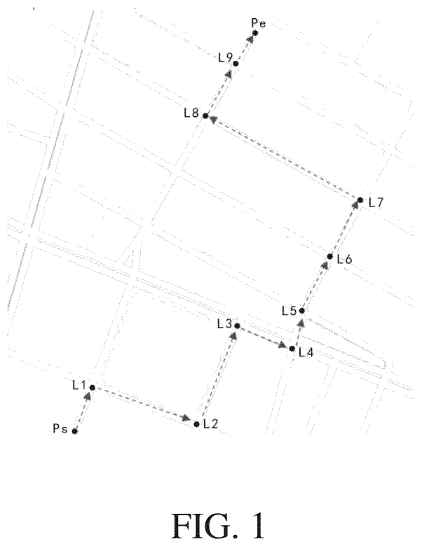

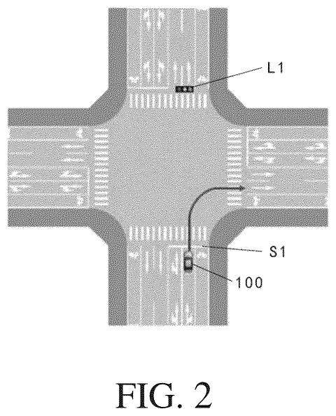

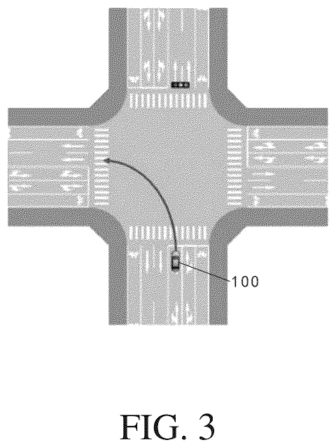

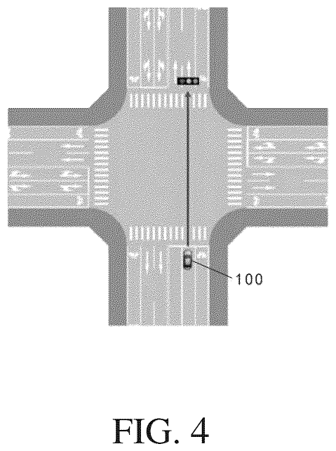

The principles of the driver assistance method of the present disclosure are described in detail below with reference to FIGS. 1-4. FIG. 1 schematically shows a point-to-point route diagram of a host vehicle from a starting point to an end point according to one example of the present disclosure. FIGS. 2, 3, and 4 schematically show routes of a host vehicle turning right, turning left, and going straight at an intersection according to one example of the present disclosure.

FIG. 1 schematically shows a point-to-point route diagram of a host vehicle from a starting point to an end point according to one example of the present disclosure. As shown in FIG. 1, a host vehicle 100 proceeds from a starting point Ps and travels to an end point Pe. Ps may be the driver's home, workplace, etc., and similarly, Pe may be the driver's workplace or home. That is, the route from Ps to Pe is a route on which the driver frequently drives the host vehicle 100. During the journey from Ps to Pe, the host vehicle 100 passes through 9 traffic lights L1-L9.

FIG. 2 schematically shows a route diagram of a host vehicle turning right at an intersection according to one example of the present disclosure. There is a traffic light L1 at this intersection. There is a crosswalk in front of the traffic light L1 and there is a stop line S1 for vehicles in front of the crosswalk. For example, the host vehicle 100 first reaches the intersection where the traffic L1 is located in the route shown in FIG. 1. When the host vehicle 100 detects the traffic light L1, it correspondingly detects the stop line S1 in front of the traffic light L1 and automatically stores the position information of the stop line S1, and the position of the stop line S1 serves as both the end position of the first section of its trip and the starting position of the second section of its trip and is used to correct accumulated positioning errors.

That is, upon reaching the first intersection, the ADAS of the host vehicle calculates the distance of the host vehicle 100 from the starting Ps to the stop line S1. In addition, the distance to the next traffic light is calculated starting from the stop line S1 and used to correct accumulated positioning errors. Furthermore, the ADAS of the host vehicle stores the mileage information and duration information from the starting point Ps to the stop line S1 as well as relevant driving path information of whether the host vehicle 100 goes straight or turns at the intersection. The driving path information at the intersection includes driving path guidance information for going straight or turning. The guidance information is used to connect the road network information of the two intersections.

Thus, according to the present disclosure, only the driving path information of the host vehicle at intersections needs to be stored, while the driving path information of the host vehicle on straight sections does not need to be stored. On straight sections of road, the host vehicle can use sensors (such as cameras, radars, and/or LiDAR) to perceive the lane lines (or obstacles) on the road to drive. Since there is no need to store the host vehicle's driving path information on straight sections, the computing resources of the vehicle's ADAS can be saved, thereby providing the user with a better travel experience.

Of course, other reference objects at the intersection of traffic light L1 can be used as the end point of the first section of the journey and the starting point of the second section. For example, if turning, the position of the crosswalk after the vehicle passes the intersection can be used as a reference object; if going straight, the position of the traffic light can be used as a reference object. After arriving at each traffic light, a reference object near the traffic light is used as the starting point for driving to the next traffic light, which can effectively eliminate the errors accumulated in various sections of the journey.

Since the host vehicle 100 will turn right at the intersection of the traffic light L1, the ADAS will calculate and store the driving path information of the host vehicle 100 turning right at the intersection of the traffic light L1. For example, relative positioning, such as the principle of vehicle motion model, can be used to set the center point of the rear axle of the host vehicle 100 when it stops before the stop line as the origin, and then the driving path information is recorded by the movement distance and position of the vehicle relative to the traffic light to form a path model of the host vehicle, while at the same time forming a connection relationship between the two paths as guidance information for the next trip. According to one example, the recorded information may also include: wheel speed pulses, steering wheel angle, global navigation satellite system (GNSS) data, inertial measurement unit (IMU) data, and other information used for path planning. The path model for forming a vehicle turning path is known in the art and will not be described in detail here.

After turning right at the intersection of the traffic light L1, the host vehicle 100 continues traveling along the lane line until reaching the intersection with the traffic light L2. The host vehicle 100 performs the same operation at the intersection of traffic light L2 as at the intersection of traffic light L1, that is, it detects the stop line in front of traffic light L2 and automatically stores the position information of the stop line, uses the position of the stop line as the end point of the second section of its trip and at the same time as the starting point of the third section of its trip, and automatically stores the mileage information and duration information of the second section and relevant driving path information on whether the host vehicle 100 is going straight or turning. And so on, until the host vehicle 100 finally reaches the end point Pe.

Therefore, according to the method of the present disclosure, a trip is first stored, wherein the trip has n traffic lights on the route from the starting point Ps to the end point Pe and the trip is divided into n+1 sections by the n traffic lights, where n is an integer greater than or equal to 1, wherein the intersection where the i-th traffic light is located has at least one i-th intersection reference object and i is any integer from 1 to n. The reference object may be, for example, a stop line at an intersection that the host vehicle cannot cross when encountering a red light, or a crosswalk after the vehicle passes through the intersection, or a traffic light at the intersection. Storing the trip comprises obtaining and storing the position information of the 1st to n-th intersection reference objects at the 1st to n-th intersections, the driving length information of each of the n+1 sections, and the driving path information of the host vehicle 100 at the 1st to n-th intersections, wherein the i-th intersection reference object serves as both the end point of the i-th section and the starting point of the i+1-th section of the trip and is used to correct the accumulated positioning error.

After the trip of the host vehicle 100 is completed, the ADAS will automatically label the trip with a name. Of course, the user can also name the trip according to his or her own habits, such as going to work, going home, etc. According to one example, for convenience, the user may also name the trip with a code, such as trip 1, trip 2, trip A, trip B, etc.

Therefore, in this trip, in addition to the information of the starting points Ps and Pe, the vehicle's ADAS only stores the position information of the stop lines corresponding to the traffic lights L1-L9 in the trip, the mileage information and duration information of each section of the trip, and the relevant driving path information of whether the host vehicle 100 goes straight or turns at the intersection where the traffic light is located. The relevant driving path information includes driving path guidance information for going straight or turning and the guidance information is used to connect the road network information of the two intersections.

After the host vehicle completes the trip, when it travels the trip again, the driver can start autonomous driving based on the name or characteristics of the first trip. Once autonomous driving is started, the ADAS automatically loads into memory the position information of the first intersection reference object (e.g., the stop line corresponding to the first traffic light L1), the length information of the first road section, and the relevant driving path information recorded by the host vehicle 100 when it first traveled the trip. The road signs simply need to be followed between the starting point and the first intersection reference object.

At a preset time Tp before the host vehicle 100 reaches the first intersection reference object, the stored information about the second intersection reference object is automatically loaded into the memory and a driving path to the second intersection reference object is planned. The preset time Tp may be set by the driver in advance based on vehicle speed and road conditions.

Of course, depending on the distance between the traffic lights and the speed of the vehicle, relevant information of two or more intersection reference objects can also be loaded each time. Users can set in advance the loading of information for several traffic light intersections at once after starting a trip. For example, if the vehicle speed is low (e.g., below 30 km/h), the relevant information of 1 traffic light can be loaded at once; when the vehicle speed is high (e.g., above 30 km/h), the relevant information of 2 or more traffic light intersections can be loaded at once. In addition, for example, when the distance between several connected road sections is short (i.e., the distance between traffic lights is short), the relevant information of 2 or more traffic light intersections can be loaded at once. That is, the position information of the reference objects of the 1st to m-th intersections that the host vehicle is about to reach, the length information of the 1st to m-th road sections, and the driving path information of the host vehicle at the 1st to m-th intersections can be loaded at once, where m≤n. For example, the value of m may be set according to the vehicle speed and the distance of each road section. That is, the value of m may be configured by the user or the ADAS according to the vehicle speed of the host vehicle and/or the lengths of the distances of the several road sections to be traversed.

According to one example of the present disclosure, the ADAS may automatically modify the information on how many traffic light intersections to load at once based on the current road traffic conditions. For example, assuming that the estimated vehicle speed is 50 km/h, the value of m is set to 3 in advance. However, in the driving process, due to poor road traffic conditions, the vehicle speed can only reach 20 km/h. At this time, the ADAS can automatically change the m value to 1. According to another example, the ADAS may automatically modify the value of m based on the time of the loaded trip. For example, if the time of the loaded trip is the morning rush hour (e.g., 07:00 a.m. to 09:00 a.m.) or the evening rush hour (e.g., 04:00 p.m. to 07:00 p.m.) from Monday to Friday, since the vehicle speed is usually lower during such time periods, when loading the trip during the above time periods, the ADAS can automatically modify the m value to a smaller value than other times.

According to the method of the present disclosure, it is only necessary to store the position information of relevant reference objects (such as stop lines) at each traffic light intersection on the entire driving route, the length information of each road section, and the relevant driving path information of whether to go straight or turn at the intersection, without the need to generate and store large maps or very long driving path information. In subsequent trips along the same route after the initial trip, it is only necessary to load the reference object position information at one or more traffic light intersections, the driving length information of one or more road sections, and the relevant driving path information at the corresponding traffic light intersections, without loading all the information for the entire trip. After starting the trip, if it does not encounter the loaded traffic light, it drives according to the lane markings. After encountering the traffic light, it drives according to the loaded driving path. According to the method of the present disclosure, the computing resources of the vehicle's ADAS can be saved, thereby providing the user with a better travel experience.

When the host vehicle 100 travels on the route again, if there are any changes in the road or environment on the route or any changes in the travel time, the ADAS can automatically record and update the relevant information. Each record and update will help make the next trip smoother, giving the user a more comfortable travel experience.

Depending on the user's needs, the user can set up and store other information besides the above information, such as business information and gas station information around the traffic light.

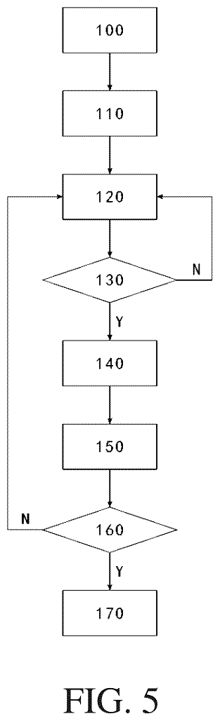

FIG. 5 schematically shows a flow chart of a method for performing a trip on a new route according to one example of the present disclosure.

First, at step 100, a new trip is started.

At step 110, a navigation map is activated for navigation by inputting a starting point Ps and an end point Pe. Proceeding to step 120, drive forward following the road signs.

At step 130, a judgment is made as to whether a traffic light is detected. If no traffic light is detected, return to step 120. If a traffic light is detected, proceed to step 140.

At step 140, the ADAS of the host vehicle 100 detects the position of a reference object (e.g., a stop line) at the intersection, stores it as the end position of the previous section and the starting position of the next section of the trip, and calculates and stores the travel length information of the previous section and the travel path information of the host vehicle at the intersection.

Then, at step 150, drive forward following the road signs.

At step 160, it is determined whether the host vehicle has reached the end point. If the end point has been reached, proceed to step 170 to end the trip. If the end point has not been reached, return to step 120.

According to this example, after the host vehicle travels a route for the first time, it is able to store in the memory the position information of relevant reference objects (such as stop lines) at each traffic light intersection on the entire driving route, the driving length information of each road section, and the relevant driving path information at each traffic light intersection.

Advantageously, the trip can be named according to the destination of the trip, such as going home, going to work, going to supermarket A, etc. According to another example, the itinerary may be named with a code, such as trip A, trip B, or trip 1, trip 2, etc.

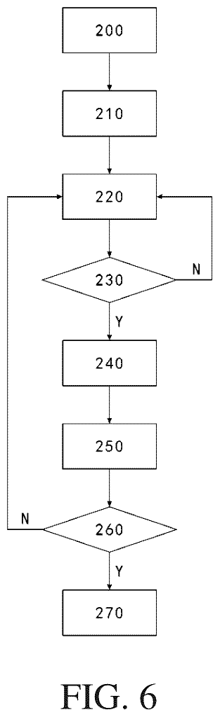

A flow chart of a method for performing a trip on a previously traveled route according to one example of the present disclosure is described below in conjunction with FIG. 6.

First, at step 200, the trip is started. According to the present disclosure, a trip may be started by entering the name or number of the trip, such as going home, going to work, going to supermarket A, or trip A, etc. For example, this may be done by manual input or voice input.

After starting the trip, at step 210, the ADAS automatically loads relevant information about the upcoming trip. According to one example, the loaded information may include location information of relevant reference objects (such as stop lines) at each traffic light intersection on the entire driving route, driving length information of each road section, and driving path information related to whether to go straight or turn.

According to another example, the loaded information may include the position information of relevant reference objects (such as stop lines) of one or more traffic light intersections ahead of the host vehicle on the travel route at the current time, the relevant driving path information, and the driving length information of one or more road sections ahead. When the host vehicle passes through one or more traffic light intersections, the ADAS automatically loads the location information of the relevant reference objects (such as stop lines) and related driving path information of the next one or more traffic light intersections to be passed as well as the driving length information of the next one or more road sections to be traveled. For example, the relevant information of 1, 2, or more intersections with traffic lights may be loaded first, and when the host vehicle passes the loaded 1, 2, or more traffic lights, the relevant information of the next 1, 2, or more intersections with traffic lights may be automatically loaded. The purpose of doing this is to effectively save computer resources and better improve the user experience.

After step 210, proceed to step 220 and drive forward following the road signs.

Then, at step 230, a judgment is made as to whether a traffic light is detected. If no traffic lights are detected, return to step 220. If a traffic light is detected, proceed to step 240.

At step 240, the host vehicle drives according to the loaded relevant information at the traffic light intersection, e.g., it can go straight or turn, and the reference object at the intersection (such as the stop line) is used as the end position of the previous section to recalculate the travel length information of the previous section and as the end position of the next section to recalculate the travel length of the next section.

Then, at step 250, drive forward following the road signs.

Then proceed to step 260. At step 260, it is determined whether the host vehicle has reached the end point. If the end point has been reached, proceed to step 270 to end the trip. If the end point has not been reached, return to step 220.

According to one example, the position information of intersection reference objects is obtained through visual sensors (such as cameras).

According to one example, the scope of the geofencing is determined by GPS/IMU and the corresponding intersection reached by the host vehicle is determined by precise positioning using visual features or semantic information.

According to one example, the host vehicle may determine whether it has reached the end point based on landmark objects near the end point detected by sensors, or it may determine whether it has reached the end point through a global positioning system (GPS), an odometer, etc. The sensors can be cameras, radio detection and ranging (RADAR), light detection and ranging (LIDAR), sound navigation and ranging (sonar), etc.

According to one example, at a predetermined time or distance before the host vehicle is about to reach the end point, the ADAS may alert the occupant of the vehicle that the end point is about to be reached. The alert may be voice, text displayed on a display, etc.

According to the method of the present disclosure, it is not necessary to store the driving path information for straight sections, but only the position information of intersection reference objects, the driving length information of each section, and the driving path information at the intersection need to be stored. Therefore, the computing resources of the vehicle's ADAS can be saved, thereby providing the user with a better travel experience.

The present disclosure also provides a non-volatile machine-readable storage medium storing instructions that can be executed by a computer system to perform the steps of the method according to the present disclosure. The non-volatile machine-readable storage medium can be a machine-readable storage device, a machine-readable storage substrate, a memory device, a composition of matter affecting a machine-readable propagated signal, or a combination of one or more thereof.

The present disclosure further provides a domain controller, comprising at least one processor and a memory coupled with the at least one processor, the memory storing a computer program implementing the method according to the present disclosure when executed by the at least one processor.

The present disclosure also provides a computer program product comprising a computer program implementing the method according to the present disclosure when executed by a computer.

Therefore, although the features of the examples have been described herein, it is understood that those skilled in the art can make various omissions, substitutions, and changes in the form and details of the methods shown and their operations, and the sequence of the steps of the above methods is merely exemplary. Adjustments to the steps of the method of the present disclosure are possible as long as the functions of the present disclosure can be achieved. For example, all combinations of method steps that perform substantially the same function in substantially the same way to achieve the same result are equivalent.

What is claimed is:

1. A driver assistance method, comprising:
storing a trip, wherein the trip has n traffic lights along a route from a starting point to an end point and the trip is divided into n+1 sections by the n traffic lights, wherein n is an integer greater than or equal to 1, wherein the intersection where the i-th traffic light is located has at least one i-th intersection reference object, and i is any integer from 1 to n, and wherein storing the trip comprises only acquiring and storing position information of the 1st to n-th intersection reference objects at the 1st to n-th intersections, travel length information of the n+1 sections, and driving path information of the host vehicle at the 1st to n-th intersections, and further wherein the i-th intersection reference object serves as both the end point of the i-th section and the starting point of the i+1-th section of the trip and is used to correct accumulated positioning errors and the driving path information at the intersection includes driving path guidance information with going straight or turning information and the driving path guidance information is used to connect the road network information of the two intersections.

2. The method according to claim 1, further comprising:
loading a trip, wherein loading the trip comprises only loading the position information of the intersection reference object of the stored trip, the length information of the road section, and the driving path information of the host vehicle at the intersection; and
during the driving process of the host vehicle, an advanced driver assistance system (ADAS) detects in real time whether it has reached an intersection with a traffic light, and if it is detected to have reached the intersection, it drives according to the loaded driving path information of the host vehicle at the intersection.

3. The method according to claim 2, wherein a scope of geofencing is determined by GPS/IMU and the corresponding intersection reached is determined by precise positioning using visual features or semantic information.

4. The method according to claim 2, wherein loading the trip comprises only loading the position information of the reference objects of the 1st to m-th intersections that the host vehicle is about to reach, the length information of the 1st to m-th road sections, and the driving path information of the host vehicle at the 1st to m-th intersections, wherein m≤n.

5. The method according to claim 4, wherein the value of m is configured by the user or the ADAS based on speed of the vehicle and/or the length of the several road sections to be passed, and wherein the higher the speed of the vehicle, the larger the value of m; and/or the shorter the distance of the several road sections to be passed, the larger the value of m.

6. The method according to claim 1, wherein during each driving of the trip, the host vehicle monitors the position information of the reference objects at the 1st to n-th intersections, the driving length information of each road section, and the driving path information of the host vehicle at the 1st to n-th intersections and updates the stored corresponding information based on the monitored information.

7. The method according to claim 1, wherein the user can set a name or code for the created trip and can load the trip with that name or code.

8. A domain controller, comprising:
at least one processor; and
a memory coupled with the at least one processor, the memory storing a computer program implementing the method according to claim 1 when executed by the at least one processor.

9. A computer program product storing a computer program, which, when executed by a processor, implements the method according to claim 1.
